(19) United States
(12) Patent Application Publication
(10) Pub. No.: US 2005/0071614 A1
(43) Pub. Date: Mar. 31, 2005

(54) Method and system for multiple branch paths in a microprocessor

(76) Inventors: Stephan Jourdan, Portland, OR (US); Per Hammarlund, Hillsboro, OR (US); Avinash Sodani, Hillsboro, OR (US); James Allen, Austin, TX (US); Francis McKeen, Portland, OR (US); Pierre Michaud, Bruz (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/676,310

(22) Filed: Sep. 30, 2003

(51) Int. Cl. G06F 9/00

(52) U.S. Cl. 712/239

(57) ABSTRACT

A method and system for multiple branch paths in a microprocessor is described. The method includes assigning an identification number (ID) to each of a plurality of micro-operations (uops) to identify a branch path to which the uop belongs, determining whether one or more branches are predicted correctly, determining which of the one or more branch paths are dependent on a mispredicted branch, and determining whether one or more of the plurality of uops belong to a branch path that is dependent on a mispredicted branch based on their assigned IDs.

### BACKGROUND

1. Technical Field

Embodiments of the invention relate to the field of microprocessors, and more specifically to multiple branch paths in a microprocessor.

2. Background Information and Description of Related Art

In current processors, branches are checked in a dedicated jump unit. This jump unit checks the branch direction and prediction. If a branch is not predicted correctly, a pipeline clear occurs, which directs the front end units of the processor to the correct instruction pointer. However, it takes many processing cycles to clear the processing units of the micro-operations (uops) related to the mispredicted branch.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a microprocessor incorporating the invention.

FIG. 2 is a branch dependency table according to an embodiment of the invention.

FIG. 3 is a flow diagram illustrating a method according to an embodiment of the invention.

FIG. 4 is a block diagram illustrating a suitable computing environment in which certain aspects of the illustrated invention may be practiced.

### DETAILED DESCRIPTION

Embodiments of a system and method for multiple branch paths in a microprocessor are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

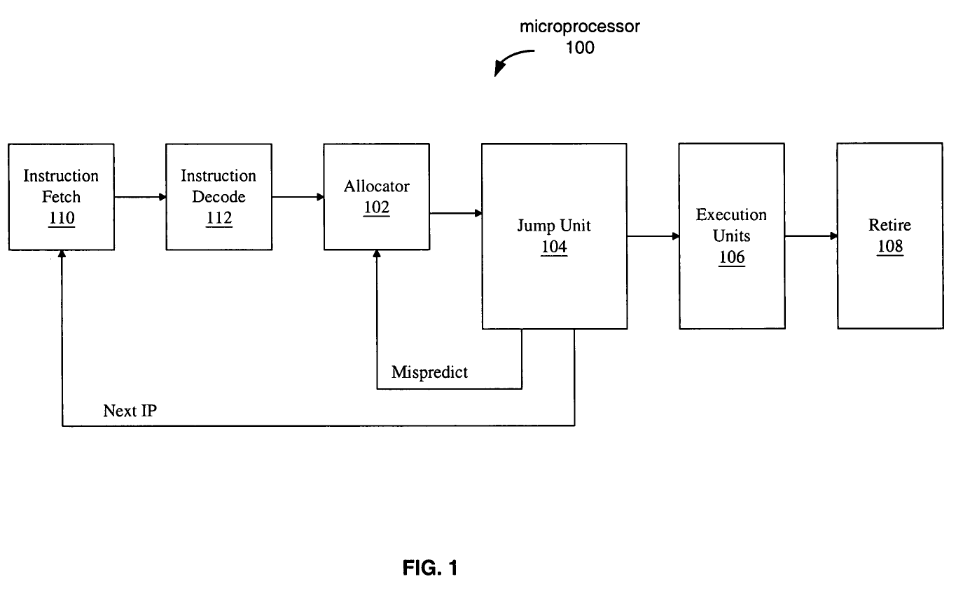

Referring to FIG. 1, a block diagram illustrates a microprocessor 100 according to one embodiment of the invention. Those of ordinary skill in the art will appreciate that the microprocessor 100 may include more components than those shown in FIG. 1. However, it is not necessary that all of these generally conventional components be shown in order to disclose an illustrative embodiment for practicing the invention.

Microprocessor 100 includes an instruction fetch unit 110, an instruction decode unit 112, an allocator 102, a jump unit 104, one or more execution units 106, and a retire unit 108. The instruction fetch unit 110 fetches instructions from the address pointed to by the next instruction pointer (IP). The instruction decode unit 112 decodes the fetched instructions into micro-operations (uops). The allocator 102 determines which branch path each uop belongs and assigns an identification number (ID) to the uop based on the branch path to which the uop belongs. In one embodiment, the ID includes a branch ID and a sequence number. Uops that belong to the same branch path are assigned the same branch ID. In one embodiment, the sequence number identifies the order of the uops that belong to the same branch path. The sequence number may be reset when the allocator assigns a new branch ID to a new branch path. In another embodiment, the sequence number is not reset and may be used to order uops across multiple branch paths.

The retire unit 106 checks whether uops are valid and retires uops in order. After the last uop of an ID has retired, that ID is reclaimed and becomes available to be reassigned to another branch path. In one embodiment, the IDs are reclaimed and assigned in order. In another embodiment, the allocator 102 maintains a list of available IDs and assigns uops an ID from the list. When there are no available IDs to assign, the allocator stalls until all uops of an ID have been retired and that ID becomes available.

The jump unit 104 determines whether branches are predicted correctly. When a branch is mispredicted, the jump unit 104 notifies the instruction fetch unit 110 and the allocator 102. The instruction fetch unit receives the correct address of the next instruction and starts to fetch instructions from this address. The instruction decode unit decodes these new instructions into uops. At the time these new uops reach the allocator 102, there may still be old uops from the previous branch path in various units of the microprocessor. Therefore, the allocator 102 assigns these new uops a different branch ID. The different branch ID identifies these new uops as belonging to a different branch path.

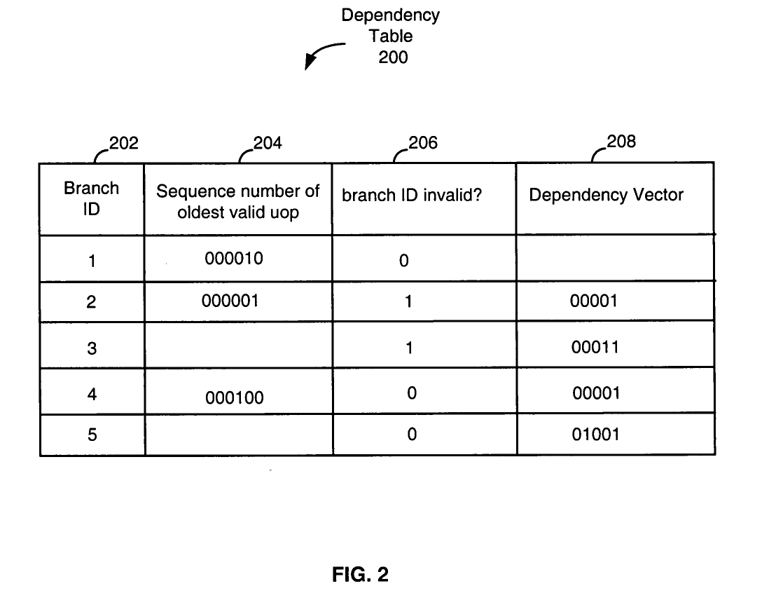

In one embodiment, the jump unit 104 maintains a table of branch dependency and validity information, such as the exemplary table shown in FIG. 2. In this table, the jump unit keeps track of the sequence number of the oldest valid uop in each branch ID. Any uop that has a sequence number greater than the sequence number of the oldest valid uop in the same branch ID is invalid. When a branch is mispredicted, the jump unit 104 updates the sequence number of the oldest valid uop of the current branch ID in the table 200.

Uops may not be executed in order in the microprocessor. Therefore, there may be invalid uops from multiple branch paths in the microprocessor pipeline at one time. For example, suppose a uop with branch ID 1 and sequence number 0101 generates a branch misprediction. The allocator will start assigning new uops a branch ID of 2. Then, suppose a uop with branch ID 1 and sequence number 0010 generates a branch misprediction. The allocator will start assigning new uops a branch ID of 3. There will then be invalid uops in the microprocessor with branch ID 1 and branch ID 2. The invalid uops with branch ID 1 may be identified by comparing their sequence number to the sequence number of the oldest valid uop, which is 0010. However, branch ID 2 was dependent on a branch prediction in branch ID 1. This branch prediction turned out to be incorrect. Therefore, all uops in branch ID 2 are invalid. This dependency and validity information is maintained in table 200.

Each time the allocator starts to assign a new branch ID to uops, jump unit 104 stores the new branch ID's dependencies in the table 200. When there is branch misprediction, the jump unit 104 checks the table to determine which branch IDs are dependent on the mispredicted branch. The branch IDs that are dependent on the mispredicted branch are marked invalid.

In one embodiment, the branch dependencies are stored as vectors. The number of bits in the dependency vector corresponds to the number of available branch IDs. Each bit of the vector represents a different branch ID from which a new branch may depend. Each dependency vector is constructed for a new branch ID by copying the vector of its parent and adding a one in the bit position representing the parent.

In one embodiment, when the last uop of a branch ID has retired and that branch ID is reclaimed, the bits in the branch table entries that correspond to the reclaimed branch ID are cleared. These cleared entries include the sequence number of the oldest valid uop, the dependency vector, and the bit that indicates whether the branch ID is valid. In another embodiment, the allocator 102 clears the bits in the branch table entries that correspond to a reclaimed branch ID when that branch ID is reassigned to a new branch path.

In one embodiment, the jump unit 104 checks whether uops are valid. In one embodiment, the jump unit 104 maintains a master copy of the branch table 200. Other copies of the branch table may be distributed to other units in the microprocessor. This enables other units in the microprocessor to check whether a uop is valid. The jump unit 104 maintains the master copy of the branch table and sends updates to other microprocessor units that have copies of the branch table. For example, an execution unit may check its copy of the branch table to determine if the branch ID assigned to a uop has been marked invalid. If the branch ID has been marked invalid, then the uop is invalid and may ignored. If the branch ID is valid, the unit may then compare the uop's sequence number to the sequence number of the oldest valid uop of the same branch ID. If the sequence number of the current uop is greater than the sequence number of the oldest valid uop of the same branch ID, then the current uop is invalid and may be ignored and retired. Otherwise, the current uop is valid and may be executed.

An example will now be discussed for illustrative purposes. In this example, the allocator is assigning uops in a first branch path a branch ID of 1. Suppose that a uop with a sequence number of 000100 in branch ID 1 generates a branch misprediction. The sequence number of 000100 is stored as the oldest valid uop. The jump unit informs the allocator of the misprediction, and the allocator starts assigning new uops a branch ID of 2. The branch ID 2 is dependent on the branch ID 1, and this information is stored in the branch dependency table.

Suppose that a uop with a sequence number of 000001 in branch ID 2 generates a branch misprediction. The jump unit informs the allocator of the misprediction. The allocator then starts to assign uops a branch ID of 3. The sequence number of 000001 is stored in the dependency table as the oldest valid uop of branch ID 2. Branch ID 3 is dependent on branch ID 2 and branch ID 1, and these dependencies are stored in the dependency table. In one embodiment, the dependency vector for branch ID 3 is constructed by copying the dependency vector of branch ID 2 (00001) and adding a one in the bit position representing branch ID 2 (second least significant bit). The result is a dependency vector of 00011 for branch ID 3.

Suppose that a uop with sequence number 000010 of branch ID 1 generates a branch misprediction. This uop has a smaller sequence number than the sequence number of the current oldest valid uop of branch ID 1 in the table. Therefore, the jump unit 104 would update the oldest valid uop sequence number to 000010 in the table. The jump unit would then determine whether there are any branch IDs dependent on the mispredicted branch. The table indicates that branch ID 2 and branch ID 3 are dependent on branch ID 1. Therefore, branch ID 2 and branch ID 3 are marked invalid. The jump unit 104 informs the allocator 102 of the branch misprediction and the allocator 102 starts to assign uops a branch ID of 4. The branch ID 4 is dependent on branch ID 1 and this information is stored in the dependency table.

Suppose an execution unit wants to check whether a uop of branch ID 1 with a sequence number of 000011 is valid. The execution unit checks its copy of the table to determine whether all uops of branch ID 1 have been determined invalid. The table indicates that some uops of branch ID 1 are valid. Therefore, the execution unit checks the table to determine the sequence number of the oldest valid uop of branch ID 1, which is 000010. Then, the execution unit compares the sequence number of the oldest valid uop to the sequence number of the current uop to determine which is greater. 000011 is greater than 000010. Therefore, the current uop with sequence number 000011 is invalid, since it is older than the oldest valid uop. Since the current uop is invalid, it may be ignored.

Suppose an execution unit wants to check whether a uop of branch ID 1 with a sequence number of 000001 is valid. The execution unit checks the table and determines that uops younger than the oldest valid uop of sequence number 000010 are valid. Since 000001 is smaller than 000010, the current uop is younger than the oldest valid uop. Therefore, the current uop is valid and may be executed.

Suppose an execution unit wants to check whether a uop of branch ID 2 with a sequence number of 000001 is valid. The execution unit checks the table, which indicates that all uops of branch ID 2 are invalid. Therefore, the uop may be ignored.

Suppose an execution unit wants to check whether a uop of branch ID 3 with a sequence number of 000001 is valid. The execution unit checks the table, which indicates that all uops of branch ID 3 are invalid. Therefore, the uop may be ignored.

Suppose an execution unit wants to check whether a uop of branch ID 4 with a sequence number of 000011 is valid. The table indicates that all uops of branch ID 4 are valid, since there have been no branch mispredictions in branch ID 4 yet. Therefore, the current uop of branch ID 4 is valid and may be executed.

Suppose that a uop of branch ID 4 with sequence number 000100 generates a branch misprediction. The allocator then starts to assign uops with a branch ID of 5. Branch ID 5 is dependent on branch ID 4 and branch ID 1, so this information is stored in the dependency table. The oldest valid uop of branch ID 4 is determined and the sequence number 000100 is stored in the dependency table. Any uops in branch ID 4 that are older than this oldest valid uop are invalid.

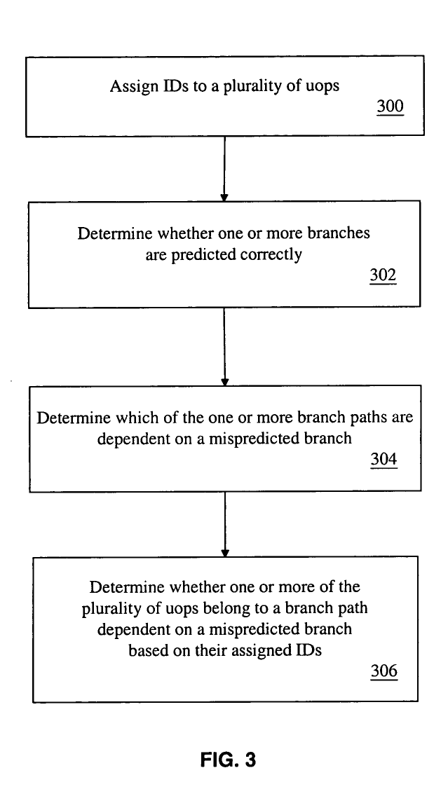

FIG. 3 illustrates a method according to one embodiment of the invention. At 300, an ID is assigned to each of a plurality of uops to identify a branch path to which the uop belongs. In one embodiment, sequence numbers are also assigned to the uops. At 302, one or more branches are checked to determine whether the branches were predicted correctly. At 304, the branch paths that are dependent on a mispredicted branch are determined. At 306, the uops that belong to a branch path that is dependent on the mispredicted branch are determined based on their assigned IDs.

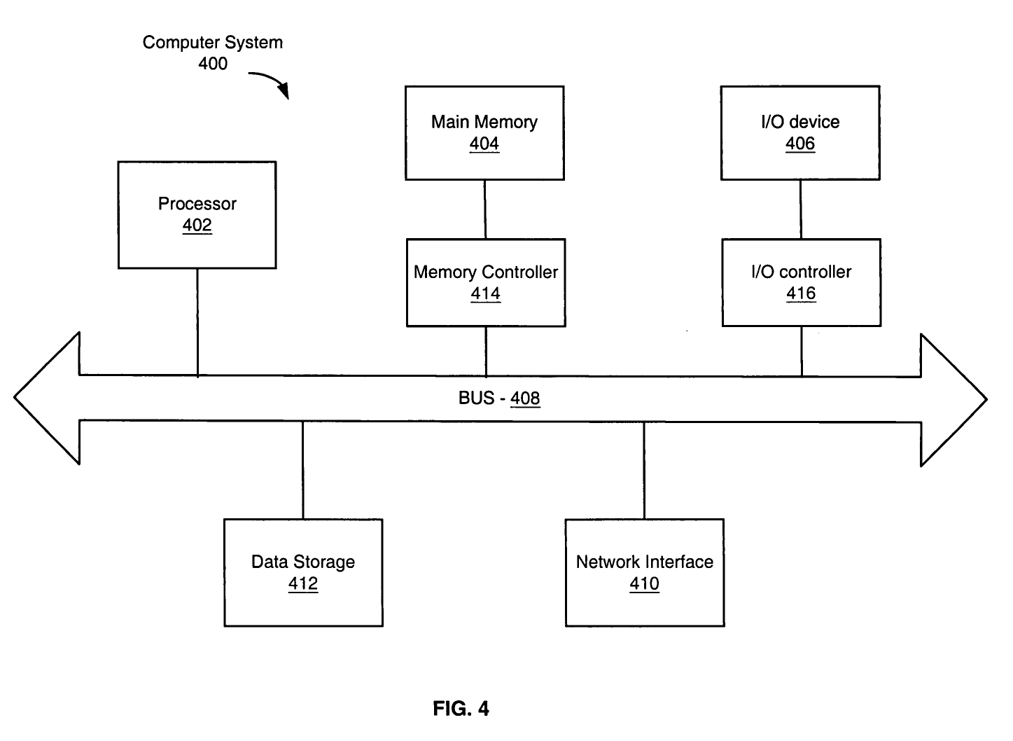

FIG. 4 is a block diagram illustrating a suitable computing environment in which certain aspects of the illustrated invention may be practiced. In one embodiment, computer system 400 has components 402-416, including a processor 402, a memory controller 414 controlling a memory 404, an Input/Output (I/O) controller 416 controlling an I/O device 406, a data storage 412, and a network interface 410, coupled to each other via a bus 408. The components perform their conventional functions known in the art. Collectively, these components represent a broad category of hardware systems, including but not limited to general purpose computer systems. It is to be appreciated that various components of computer system 400 may be rearranged, and that certain implementations of the present invention may not require nor include all of the above components. Furthermore, additional components may be included in system 400, such as additional processors, storage devices, memories, and network or communication interfaces.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
assigning an identification number (ID) to each of a plurality of micro-operations (uops) to identify a branch path to which the uop belongs;
determining whether one or more branches are predicted correctly;
determining which of the one or more branch paths are dependent on a mispredicted branch; and
determining whether one or more of the plurality of uops belong to a branch path that is dependent on the mispredicted branch based on their assigned IDs.

2. The method of claim 1, further comprising retiring a uop that belongs to a branch path dependent on a mispredicted branch.

3. The method of claim 1, further comprising assigning each of the plurality of uops a sequence number.

4. The method of claim 3, further comprising storing the sequence number of an oldest valid uop in each branch path.

5. The method of claim 4, further comprising comparing the sequence number of a uop to the sequence number of the oldest valid uop in a same branch path.

6. The method of claim 1, further comprising maintaining a list of available IDs.

7. The method of claim 6, wherein assigning an ID to each of a plurality of uops to identify a branch path to which the uop belongs comprises assigning by an allocator an ID for each of the plurality of uops from the list of available IDs.

8. The method of claim 7, further comprising stalling the allocator if there is no available ID to be assigned.

9. The method of claim 7, further comprising placing an ID on the list of available IDs when all uops that have been assigned that ID have been retired.

10. An apparatus comprising:
an allocator to assign a plurality of micro-operations (uops) identification numbers (IDs), each ID to identify a branch path to which the uop belongs;
a jump unit coupled to the allocator to determine whether branches are predicted correctly; and
an execution unit coupled to the jump unit to determine which uops belong to a branch path that is dependent on a mispredicted branch based on their assigned IDs.

11. The apparatus of claim 10, further comprising a retire unit coupled to the jump unit to retire uops that are related to a mispredicted branch.

12. The apparatus of claim 11, wherein the allocator to further maintain a list of available IDs and assign an ID for each branch from the list of IDs.

13. The apparatus of claim 12, wherein the retire unit to further place an ID on the list of available IDs when all uops that have been assigned that ID have been retired.

14. The apparatus of claim 10, wherein the allocator to further assign each of the plurality of uops a sequence number.

15. The apparatus of claim 14, wherein the jump unit to further store the sequence number of the oldest valid uop in each branch path.

16. The apparatus of claim 15, wherein the execution unit to further compare the sequence number of a uop to the sequence number of an oldest valid uop in a same branch path.

17. The apparatus of claim 10, further comprising an instruction fetch unit coupled to the allocator to fetch a next instruction based on a next instruction pointer.

18. The apparatus of claim 17, further comprising an instruction decode unit coupled to the instruction fetch unit to decode the fetched instructions.

19. A system comprising:
an input/output (I/O) controller; and
a processor coupled to the I/O controller, the processor including:
an allocator to assign micro-operations (uops) identification numbers (IDs), each ID to identify a branch path to which the uop belongs;
a jump unit coupled to the allocator to determine whether branches are predicted correctly; and
an execution unit coupled to the jump unit to determine which uops belong to a branch path that is dependent on a mispredicted branch based on their assigned IDs.

20. The system of claim 19, wherein the processor further comprises a retire unit coupled to the jump unit to retire uops that are related to a mispredicted branch.

21. The system of claim 19, wherein the processor further comprises an instruction fetch unit coupled to the allocator to fetch a next instruction based on a next instruction pointer.

22. The system of claim 21, wherein the processor further comprises an instruction decode unit coupled to the instruction fetch unit to decode the fetched instructions.
